(19) United States
(12) Patent Application Publication
(10) Pub. No.: US 2016/0247639 A1
(43) Pub. Date: Aug. 25, 2016

(54) INTEGRATED POTENTIOMETER AND MOMENTARY SWITCH

(71) Applicant: Bourns, Inc., Riverside, CA (US)

(72) Inventors: Minh NGUYEN, Garden Grove, CA (US); Thanh NGUYEN, Riverside, CA (US); Gary DAILEY, Riverside, CA (US); John DOOHALUK, Jurupa Valley, CA (US)

(21) Appl. No.: 15/045,069

(22) Filed: Feb. 16, 2016

Related U.S. Application Data
(60) Provisional application No. 62/117,413, filed on Feb. 17, 2015.

(51) Int. Cl. H01H 3/02; H01H 13/52; H01C 10/50; H01H 13/20; H01H 11/06

(52) U.S. Cl. CPC H01H 3/0213; H01H 13/20; H01H 11/06; H01C 10/50; H01H 13/52

(57) ABSTRACT

Integrated potentiometer and momentary switch. In some embodiments, a device can include a housing and one or more structures implemented within the housing and defining a first surface and a second surface. The device can further include a switch implemented on the first surface, and a potentiometer implemented on the second surface. The device can further include an actuator mechanism configured to allow the switch to transition between ON and OFF states, and to allow adjustment of the potentiometer when the switch is in the ON state or the OFF state.

### CROSS-REFERENCE TO RELATED APPLICATION(S)

This application claims priority to U.S. Provisional Application No. 62/117,413 filed Feb. 17, 2015, entitled INTEGRATED POTENTIOMETER AND MOMENTARY SWITCH, the disclosure of which is hereby expressly incorporated by reference herein in its entirety.

### BACKGROUND

1. Field

The present disclosure relates to integration of potentiometer and momentary switch.

2. Description of the Related Art

Many electronic devices and circuits utilize one or more potentiometers and one or more momentary switches. A potentiometer typically includes a three-terminal resistance functionality to provide an adjustable voltage divider functionality. A momentary switch is typically configured to change its switching state (e.g., OFF to ON) momentarily during application of, for example, mechanical force. Once such a mechanical force is removed, the momentary switch returns to its original state (e.g., ON to OFF).

### SUMMARY

In some implementations, the present disclosure relates to a device that includes a housing, and one or more structures implemented within the housing and defining a first surface and a second surface. The device further includes a switch implemented on the first surface, and a potentiometer implemented on the second surface. The device further includes an actuator mechanism configured to allow the switch to transition between ON and OFF states, and to allow adjustment of the potentiometer when the switch is in the ON state or the OFF state.

In some embodiments, the switch can be a momentary switch. In some embodiments, the one or more structures can include a plate having a first side defining the first surface and a second side defining the second surface. The switch can include first and second switch contacts implemented on the first surface, and the potentiometer can include a resistive element implemented on the second surface. The actuator mechanism can include a shaft that extends between the first and second sides of the plate.

In some embodiments, the switch can further include a flexible conductor configured to electrically connect or disconnect the first and second switch contacts, depending on a longitudinal position of the shaft. The flexible conductor can include a dome-shaped conductor configured to deform in a restorable manner. The actuator mechanism can be configured to allow adjustment of the potentiometer in any shape state of the dome-shaped conductor.

In some embodiments, the potentiometer can include a rotor coupled to the shaft, and the rotor can be configured to facilitate variable resistance settings between respective ends of the resistive element and a collector node. The rotor can include a sliding contact configured to slide along the resistive element when the rotor is turned by the shaft.

In some embodiments, the device can further include a gear assembly configured to couple the rotor and the shaft. The gear assembly can include one or more drive wheels mounted on the rotor and configured to engage the shaft. The gear assembly can further include a teeth pattern dimensioned to engage the one or more drive wheels such that rotation of the shaft results in the rotor rotating relative to the teeth pattern.

In some embodiments, the rotor can be coupled substantially directly to the shaft in a slidable manner. The shaft can include a drive key, and the rotor can include a keyhole dimensioned to receive the drive key, such that rotation of the shaft results in rotation of the rotor. The drive key can be dimensioned with sufficient length to allow longitudinal motion of the drive key through the keyhole as the shaft is moved to transition the switch between the ON and OFF states.

In some embodiments, the device can further include a first set of terminals electrically connected to the switch contacts, and a second set of terminals electrically connected to the ends of the resistive element and the collector node.

In some embodiments, the housing can include a front lid and a molded back implemented such that the plate is positioned between the front lid and the molded back. The switch can be implemented between the plate and the front lid, and the potentiometer can be implemented between the plate and the molded back.

In some embodiments, the actuator can include a turn-facilitating feature implemented at a front end of the shaft, and the front lid can include an opening to facilitate turning of the shaft with the turn-facilitating feature. The turn-facilitating feature can include a slot or a tab.

In some embodiments, the actuator can further include a disk implemented to be positioned adjacent an inner surface of the front lid to retain the actuator inward of the front lid. In some embodiments, the disk can include either or both of a visual indicator and a detent receiver. The visual indicator can be configured to provide an indication of a rotational position of the rotor of the potentiometer, and the detent receiver can be configured to provide a mechanical indication of a step of rotation of the rotor of the potentiometer.

In some embodiments, the front lid can include one or more slits configured to allow viewing of the visual indicator of the disk. The one or more slits can be formed to yield one or more corresponding strips on the front lid between the one or more slits and the opening of the front lid. At least one of the one or more strips can include a detent feature configured to engage with the detent receiver of the disk. In some embodiments, the front lid can be formed from a metal sheet.

In some implementations, the present disclosure relates to a method for fabricating an electronic device. The method includes forming or providing a housing, and forming or providing one or more structures within the housing and defining a first surface and a second surface. The method further includes implementing a switch on the first surface, and implementing a potentiometer on the second surface. The method further includes implementing an actuator to allow the switch to transition between ON and OFF states, and to allow adjustment of the potentiometer when the switch is in the ON state or the OFF state.

In some implementations, the present disclosure relates to a method for fabricating a plurality of electronic devices. The method includes forming or providing a lead frame assembly having an array of lead units attached to one or more frames. The method further includes forming a plate for each lead unit. The method further includes implementing a switch on a first surface of each plate, and implementing a potentiometer on a second surface of each plate.

In some embodiments, the method can further include electrically connecting contacts of the switch and contacts of the potentiometer with corresponding leads of each lead unit. The method can further include implementing an actuator for each lead unit to allow the switch to transition between ON and OFF states, and to allow adjustment of the potentiometer when the switch is in the ON state or the OFF state. The method can further include forming at least a portion of a housing about each plate to facilitate the operation of the switch and the potentiometer.

In some embodiments, the method can further include separating each lead unit from the one or more frames to yield a plurality of individual units. Each individual unit can include remaining portions of the leads. The method can further include shaping the remaining portions of the leads for form external terminals for the switch and the potentiometer.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows a device having a switch and a potentiometer integrated together.

FIGS. 2A and 2B show side views of an example embodiment of a device in a first switch state and a second switch state, respectively.

FIG. 3 shows an example of a resistive element that can be implemented for a potentiometer.

FIGS. 4A and 4B show circuit representations of the switch and potentiometer corresponding to the switch states of FIGS. 2A and 2B.

FIG. 5 shows a simplified block diagram of an example device having one or more features as described herein.

FIG. 6 shows a table with example states that can be implemented with the device of FIG. 5.

FIG. 7 shows a simplified block diagram of another example device having one or more features as described herein.

FIG. 8 shows a table with example states that can be implemented with the device of FIG. 7.

FIG. 9 shows a simplified block diagram of yet another example device having one or more features as described herein.

FIG. 10 shows an example of an integrated potentiometer and momentary switch device in its assembled configuration.

FIG. 11 shows a back side of the device of FIG. 10.

FIGS. 12A, 12B and 12C show front, side and back views, respectively, of the example assembled device of FIG. 10.

FIG. 13 shows an example electrical configuration that can be implemented through five terminals of the device of FIGS. 12A-12C.

FIGS. 14A and 14B exploded front perspective and back perspective views of the device of FIG. 10.

FIGS. 15A and 15B show exploded front perspective and back perspective views of a portion of an integrated potentiometer and switch device, in which mechanical coupling can be provided between a shaft and a rotor through drive wheels.

FIGS. 16A and 16B show an example device in which switch contacts for a switch and a resistive pattern for a potentiometer can be implemented on different structures.

FIG. 17 shows an assembled view of another example device having a switch and a potentiometer integrated therein.

FIGS. 18A and show unassembled views of the device of FIG. 17.

FIG. 19 shows that in some embodiments, integrated potentiometer and switch devices having one or more features as described herein can be fabricated in an array utilizing lead frame technology.

FIG. 20 shows an example process that can be implemented to fabricate a plurality of devices having one or more features as described herein.

### DETAILED DESCRIPTION OF SOME EMBODIMENTS

The headings provided herein, if any, are for convenience only and do not necessarily affect the scope or meaning of the claimed invention.

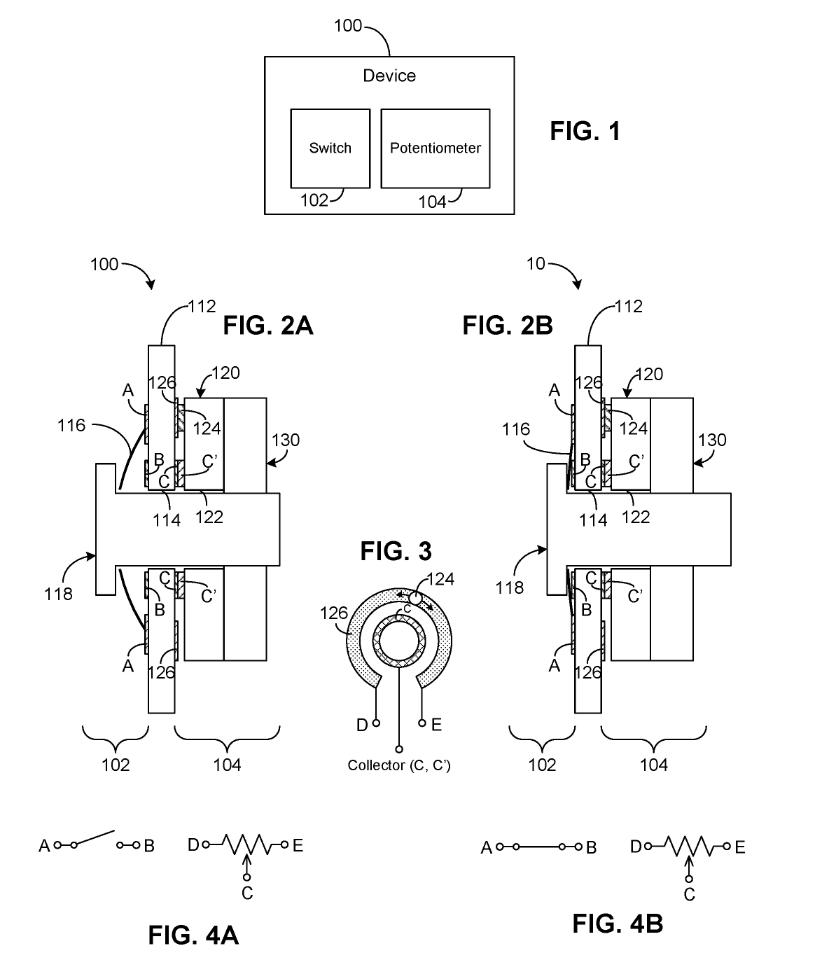

FIG. 1 shows a device 100 having a switch 102 (e.g., a momentary switch) and a potentiometer 104 integrated together. Various examples related to such a device are described herein. It will be understood that while some or all of such examples are described in the context of momentary switches and potentiometers, one or more features of the present disclosure can also be implemented with, for example, a non-momentary switch, a variable resistor, or any combination thereof.

FIGS. 2A and 2B show side views of an example embodiment of a device 100 with housing removed for clarity. A plate 112 is shown to define an opening 114 dimensioned to allow movement of a shaft 118. One side of the plate 112 (left side as shown in FIGS. 2A and 2B) includes components of a switch 102, and the other side of the plate 112 (right side) includes components of a potentiometer 104. For the purpose of description, it will be understood that such a plate can be, for example, a molded structure, a printed circuit board (PCB), a ceramic plate, or any structure suitable for formation of circuit elements to facilitate functionalities of either or both of the switch 102 and the potentiometer 104.

The shaft 118 can be pushed and released along its longitudinal axis to, for example, close (FIG. 2A) and open (FIG. 2B) the switch 102 between nodes A and B. FIGS. 4A and 4B show open and closed switch states between the nodes A and B corresponding to FIGS. 2A and 2B, respectively. Referring to the open state of FIGS. 2A and 4A, nodes A and B are not electrically connected when the shaft 118 is at the left-ward position due to a relaxed configuration of a flexible conductive dome 116. One or more edge portions of the conductive dome 116 are shown to be electrically connected to node A; and when in its relaxed configuration, the curvature of the conductive dome 116 prevents the dome 116 from contacting node B, to thereby open the circuit between nodes A and B.

Referring to the closed state of FIGS. 2B and 4B, nodes A and B are electrically connected when the shaft 118 is at the right-ward position due to the conductive dome 116 being deformed by the right-ward pushing of the shaft 118. In the deformed state, one or more inner portions of the conductive dome 116 is shown to contact node B, and therefore form an electrical connection between nodes A and B, to thereby close the circuit between nodes A and B. When the shaft 118 is released, the dome shape can be restored to the configuration of FIG. 2A to thereby return to the open-circuit state. Accordingly, the example switch of FIGS. 2A and 2B can be a momentary contact switch.

In the device of FIGS. 2A and 2B, the shaft 118 can also be rotated about its longitudinal axis. Such a rotation can be facilitated by a number of features implemented at its exposed tip (e.g., on the left end as shown in FIGS. 2A and 2B). For example, a screw-head feature on the shaft 118 can be implemented to allow turning with a tool such as a driver. In another example, a tab feature can be implemented on the shaft 118 to facilitate turning of the shaft 118.

As described herein, apertures in the conductive dome 116 and the plate 112 (indicated as 114) can allow such rotation (as well as plunging movements) of the shaft 118. The shaft 118 is shown to be coupled to a rotor 120 through a gear assembly or a coupling mechanism 130. Such a gear assembly/coupling mechanism can allow the rotor 120 to rotate with some gear ratio relative to the rotation of the shaft 118, substantially directly with the rotation of the shaft 118, or any combination thereof. Examples of the mechanical coupling between the shaft 118 and the rotor 120 are described herein in greater detail.

The rotor 120 is also shown to define an aperture 122 to allow plunging motions of the shaft 118 without the rotor 120 having to move longitudinally. The gear assembly/coupling mechanism 130 can also facilitate such plunging motions without causing the rotor 120 to move longitudinally. Such longitudinally stationary nature is generally needed or desired to allow electrical contacts on the rotor 120 to remain engaged with electrical contacts on the right surface of the plate 112 for potentiometer functionality.

Referring to FIGS. 2A, 2B and 3, the rotor 120 can include a wiper contact 124 which is electrically connected to a collector contact C′ also on the rotor 120. The collector contact C′ can remain engaged with a collector contact C on the right surface of the plate 112. The wiper contact 124 can remain engaged to a circular resistive element 126 between nodes D and E. Accordingly, depending on the azimuthal position of the wiper contact 124 on the resistive element 126, resistance between C and D (R_{CD}) varies in a sliding manner with resistance between C and E (R_{CE}) to thereby provide potentiometer functionality (e.g., see the circuit representation in FIGS. 4A and 4B).

Based on the foregoing, one can see that the potentiometer 104 can be adjusted while the switch 102 is in either open or closed state. Similarly, the switch 102 can be turned on or off without changing the potentiometer setting.

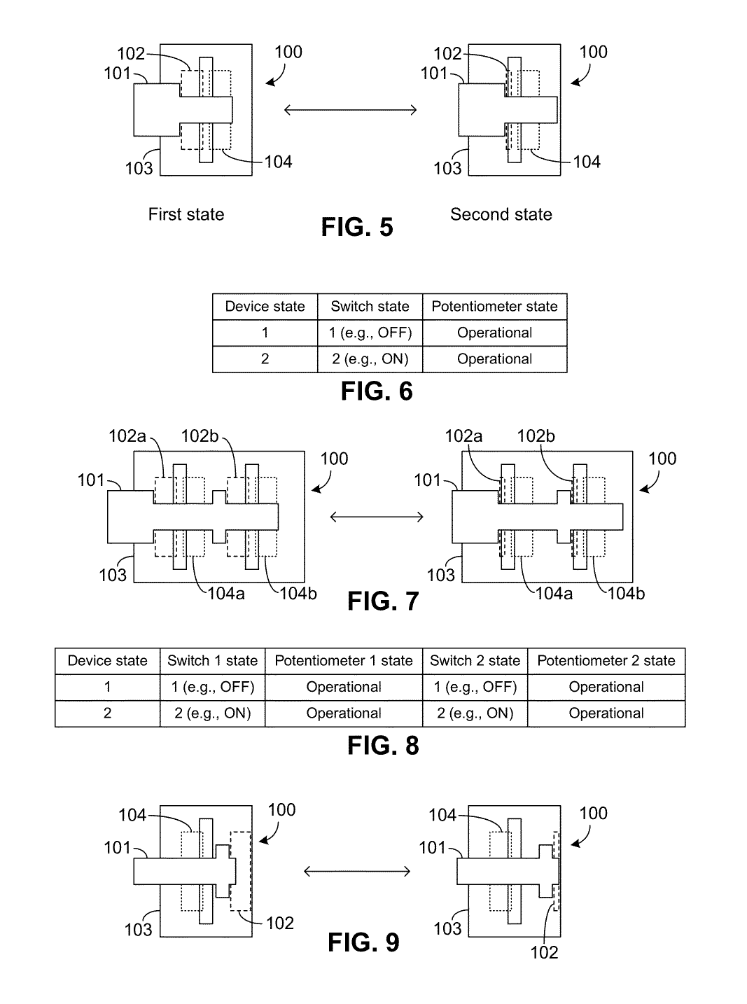

The device 100 described in reference to FIGS. 2A and 2B is an example where a switch 102 is implemented on one side of a plate, and a potentiometer 104 is implemented on the other side of the plate. FIG. 5 shows a simplified block diagram of a device 100 having such a configuration. In FIG. 5, the device 100 is shown with a housing 103 configured to house some or all of components associated with a switch 102 and a potentiometer 104. The switch 102 is shown to be implemented on one side (e.g., left side in FIG. 5) of a plate, and the potentiometer 104 is shown to be implemented on the other side (e.g., right side) of the plate. Operations of the switch 102 and the potentiometer 104 are shown to be implemented by an actuator 101 (e.g., shaft 118 in FIGS. 2A and 2B).

For the purpose of description, it will be understood that terms actuator and shaft can be used interchangeably in some contexts.

In the example of FIG. 5, and referring to a table in FIG. 6, a first state of the device 100 can include the switch 102 being in a first state (e.g., OFF or open), and a second state of the device can include the switch being in a second state (e.g., ON or closed). In each of the first and second states of the device 100, the potentiometer 104 can remain operational.

The example of FIG. 5 includes a configuration where a pair of switch and potentiometer functionalities is implemented in a given device. It will be understood that in some embodiments, a device can include more than one switch and/or more than one potentiometer.

For example, FIG. 7 shows a device 100 having two switches 102a, 102b and two potentiometers 104a, 104b. Such a device can include a housing 103 configured to house some or all of components associated with such switches and potentiometers. The device 100 can further include an actuator 101 configured to actuate the two switches 102a, 102b and/or to operate the two potentiometers 104a, 104b. Such two pairs of switch/potentiometer combinations are shown to be implemented on two separate plates.

FIG. 8 shows a table with example states of the device 100. For example a first state of the device 100 can include each of the two switches 102a, 102b being in a first state (e.g., OFF or open), and a second state of the device 100 can include each of the two switches 102a, 102b being in a second state (e.g., ON or closed). In each of the first and second states of the device 100, each of the two potentiometers 104a, 104b can remain operational.

In the examples of FIGS. 5 and 7, it is noted that the respective switches are implemented on sides (e.g., left sides as shown in FIGS. 5 and 7) of the respective plates. FIG. 9 shows that in some embodiments, a switch can be implemented away from a plate having a potentiometer functionality.

For example, a device 100 of FIG. 9 is shown to include a housing 103 configured to house some or all of components associated with a switch 102 and a potentiometer 104. An actuator 101 can be implemented to provide switching and potentiometer adjustment functionalities as described herein. The potentiometer 104 is shown to be implemented on one side of a plate (e.g., on the left side of the plate as shown in FIG. 9) so as to be coupled with the actuator 101. The switch 102, however, is shown to be implemented on the housing 103, away from the plate. Thus, the actuator 101 can be configured appropriately to actuate the switch 101 ON and OFF relative to the housing 103.

One can see that a number of different combinations of switch(es) and potentiometer(s) can be implemented utilizing one or more features of the present disclosure.

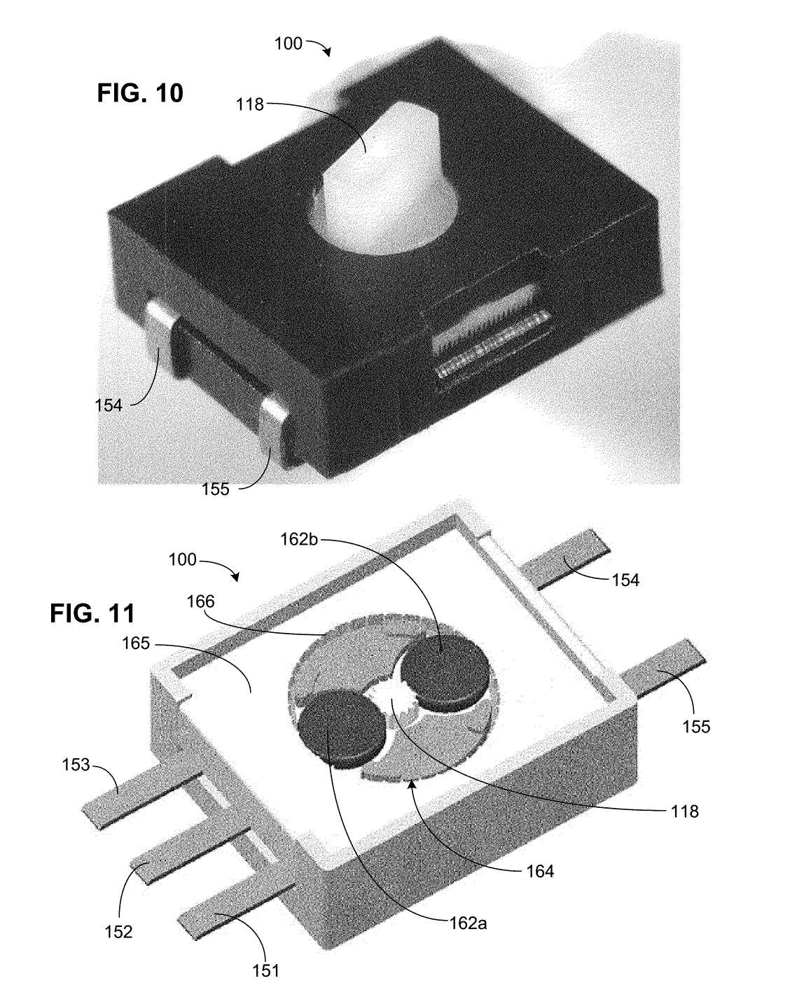

FIG. 10 shows an example of an integrated potentiometer and momentary switch device 100 in its assembled configuration. For the purpose of description, a shaft and its turn-facilitating feature (e.g., a slot or a tab) are collectively referred to as a shaft 118. As also described herein, such a shaft can function as an actuator to actuate a switch and/or to operate a potentiometer. In the example of FIG. 10, a housing is shown to allow such a shaft to be turned (to operate a potentiometer) and/or be plunged (to operate a switch). The housing is also shown to allow formation of various terminals (e.g., 154, 155) to be implemented to allow the device 100 to be mounted to, for example, a circuit board.

For the purpose of description, the side of the device on which the shaft 118 is configured for turning can be considered the front side of the device. FIG. 11 shows the back side of the same device 100, partially exposed to show an example of how the shaft 118 can be mechanically coupled to a rotor 164 to provide potentiometer functionality. Additional details concerning such mechanical coupling are described herein in greater detail. In some embodiments, mechanical coupling between the shaft 118 and the rotor can be more direct without intermediate gears. Additional details concerning such more direct mechanical coupling are described herein in greater detail.

Referring to FIGS. 10 and 11, terminals 151, 152, 153, 154 and 155 can correspond to the nodes D, C, E, A and B, respectively, described in reference to FIGS. 4A and 4B. In FIG. 10 the terminals are shown to be folded over the housing to their final forms. In FIG. 11 the terminals are shown to be in their pre-bending state. Examples related to such terminals and how at least some of the device can be fabricated as lead frames utilizing such terminals are described herein in greater detail.

Referring to FIG. 11, the shaft 118 is shown to include gear teeth configured to mesh with gear teeth of drive wheels 162a, 162b (also referred to herein as planetary drive wheels). The drive wheels 162a, 162b can be rotatably mounted to the rotor 164, such that rotation of the shaft 118 causes each drive wheel to rotate about its rotation axis.

Referring to FIG. 11, each drive wheel is shown to be coupled to gear teeth 166 formed on the inner wall of an aperture of a molded housing 165. Thus, the rotation of each drive wheel caused by the shaft 118 results in the rotor 164 rotating about the shaft 118 due to the engagement of the drive wheel with the gear teeth 166. As described herein, the other side of the rotor 164 can include electrical components that provide potentiometer functionalities.

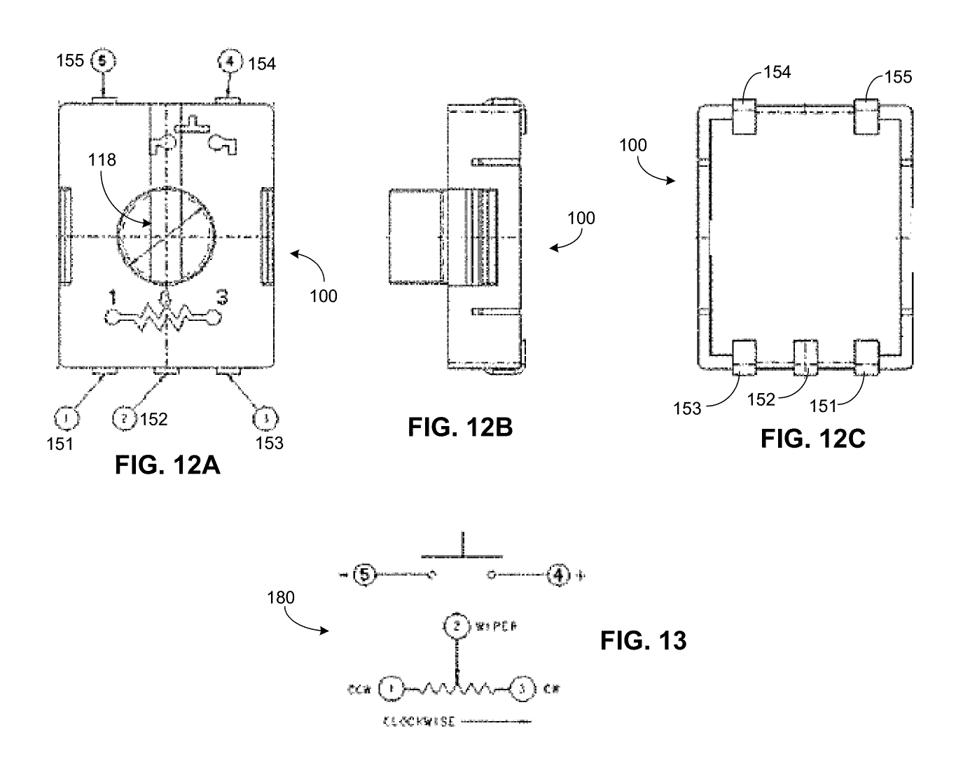

FIGS. 12A, 12B and 12C show front, side and back views, respectively, of the example assembled device 100 of FIG. 10. FIG. 13 shows an example electrical configuration that can be implemented through the five terminals of the device 100 of FIGS. 12A-12C. It will be understood that various dimensions can be implemented in the example of FIGS. 12A-12C. For example, the land pattern of the terminals (as shown in FIG. 12C) can be configured so that the two switch terminals 154, 155 are spaced approximately as wide as the two outer ones (151, 153) of the potentiometer terminals 151, 152, 153 to thereby provide improved stability when mounted.

In the example of FIGS. 12A-12C, integrated switching and potentiometer functionalities can be visually indicated on the housing. For example, FIG. 12A shows that the switch configuration can be visually noted on the front surface of the housing, adjacent to the switch terminals 154, 155. Similarly, the potentiometer configuration can be visually noted on the front surface of the housing, adjacent the potentiometer terminals 151, 152, 153. Such an arrangement of visual indicators relative to their respective terminals can allow easier mounting and/or operation of the integrated device 100.

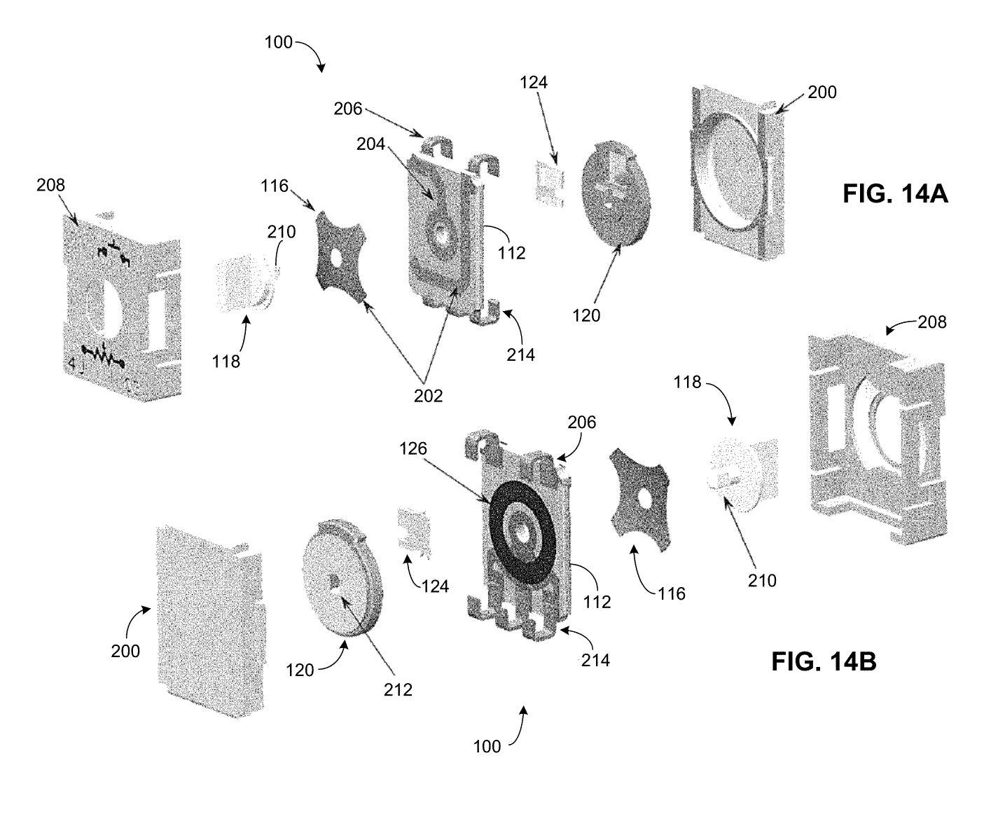

FIG. 14A shows an exploded front perspective view of the integrated potentiometer and switch device 100 of FIG. 10. FIG. 14B shows an exploded back perspective view of the same device 100.

In the example of FIGS. 14A and 14B, a lid 208 can be secured to a molded housing 200 (e.g., with snap tabs) with various parts secured therebetween. On the lid side, a switch can be implemented on one side of a plate 112 configured as a lead frame element as described herein with a shaft 118, a switch dome 116, and switch contacts 202, 204 formed on the switch side of a lead frame element 112.

On the potentiometer side, a potentiometer can be implemented on the other side of the lead frame element 112 as described herein with a shaft drive key 210 of the shaft 118, a rotor 120 having a keyhole 212 dimensioned to receive the shaft drive key 210, a sliding contact 124 (e.g., a stamped C/S), and a resistive pattern 126 formed on the potentiometer side of the lead frame element 112.

In the example of FIGS. 14A and 14B, the shaft 118 and the rotor 120 can be coupled directly through the shaft drive key 210 being inserted in the keyhole 212 of the rotor 120. The shaft drive key 210 can be dimensioned with sufficient length to facilitate sliding movements of the shaft drive key 210 through the keyhole 212 as the shaft 118 is plunged and released. Accordingly, the potentiometer can be operated whether the switch is in the plunged position, released position, or any position therebetween.

In the example of FIGS. 14A and 14B, the shaft 118 and the lid 208 can be configured to, for example, allow a tab of the shaft 118 to be turned to thereby turn the rotor 120. In another example, the shaft 118 and the inner portion of the lid 208 can be dimensioned to allow the shaft 118 to be retained.

In the example of FIGS. 14A and 14B, the molded housing 200 can include a recess dimensioned to receive the rotor 120 and to allow the rotor to rotate. The recess can be dimensioned sufficiently deep, and/or an additional cutout can be provided, to accommodate the movements of the shaft drive key 210 through the keyhole 212.

In the example of FIGS. 14A and 14B, terminals 206 formed from leads can be coupled to their respective contacts of the switch contacts 202, 204. Similarly, terminals 214 formed from leads can be coupled to their respective contacts of the potentiometer. Such terminals can be shaped after the housing is assembled so as to form terminals suitable for mounting onto, for example, a circuit board.

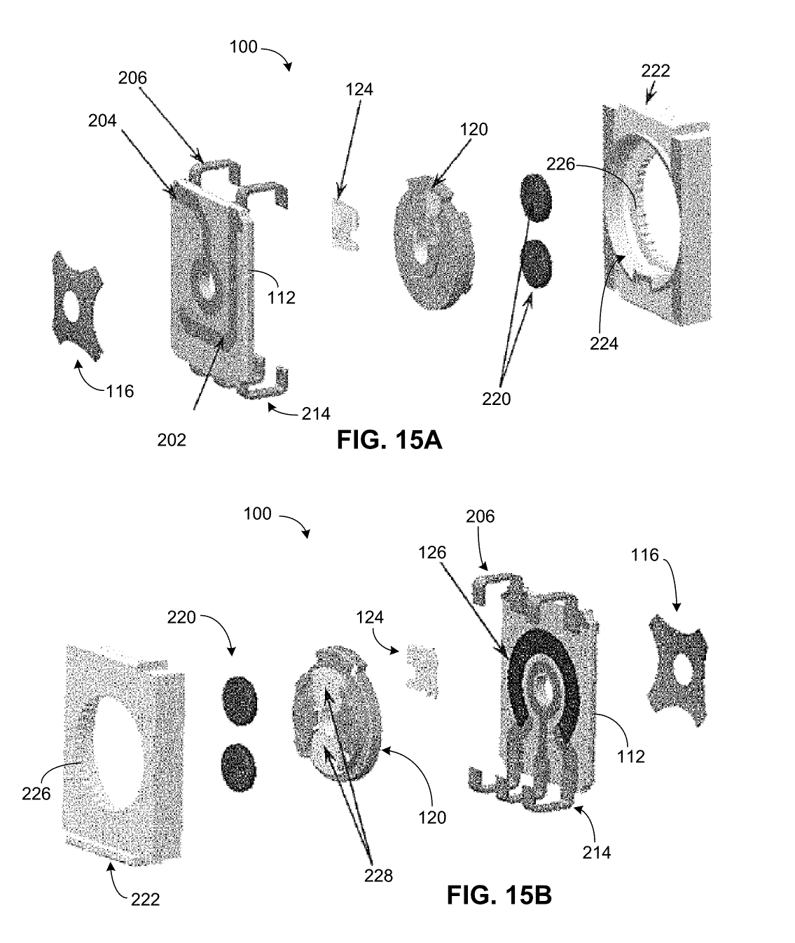

FIG. 15A shows an exploded front perspective view of a portion of an integrated potentiometer and switch device 100 in which mechanical coupling is provided through drive wheels similar to the example of FIG. 11. FIG. 15B shows an exploded back perspective view of a portion of the same device 100. In the example of FIGS. 15A and 15B, one can see how the drive wheels 220 can be positioned relative to a rotor 120 and a teeth-equipped aperture 226 of a molded housing 222 to facilitate rotation of the rotor 120 for potentiometer functionality.

In the example of FIGS. 15A and 15B, the teeth-equipped aperture 226 of the molded housing 222 for engaging the drive wheels 220 can be positioned so that the rotor 120 is between such teeth-equipped aperture and the lead frame element 112 (with a resistive pattern 126).

In the example of FIGS. 15A and 15B, the rotor 120 can include recesses for the drive wheels 220. Such recesses can allow the drive wheels to be retained relative to the teeth-equipped aperture 226 of the molded housing 222, as well as teeth-equipped portion of the shaft (e.g., 118 in FIG. 11), to facilitate rotation of the rotor 112 for potentiometer functionality.

In the example of FIGS. 15A and 15B, the switch portion (including a switch dome 116, switch contacts 202, 204 and terminals 206) can be configured similar to the example of FIGS. 14A and 14B. Similarly, the potentiometer portion (including a sliding contact 124, a resistive pattern 126 and terminals 214) can be configured similar to the example of FIGS. 14A and 14B.

It is noted that in the example of FIG. 14B, the resistive pattern 126 is depicted as having substantially a 360 degree coverage, while in the example of FIG. 15B, the resistive pattern 126 is depicted as having a coverage less than 360 degrees. It will be understood that either of such resistive pattern configurations can be implemented in a potentiometer having one or more features as described herein. It will also be understood that a potentiometer having one or more features as described herein can be implemented as a single turn device, or as a device capable of more than one turn.

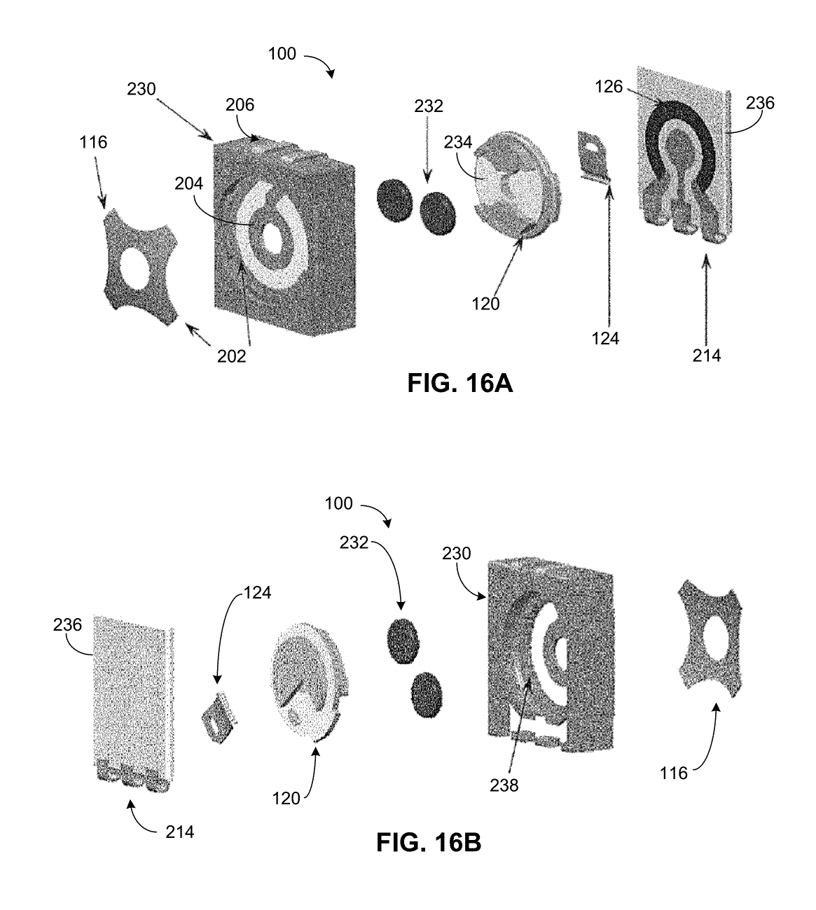

In the examples of FIGS. 14 and 15, switch contacts (202, 204) for the switch and a resistive pattern (126) for the potentiometer are shown to be implemented on opposite sides of the same lead frame element (112). It will be understood that other configurations can also be implemented. For example, FIGS. 16A and 16B show an example device 100 in which switch contacts 202, 204 for a switch and a resistive pattern 126 for a potentiometer can be implemented on different structures.

More particularly, the switch contacts 202, 204 are shown to be implemented on a first side of a molded housing 230. Such contacts and the first side of the molded housing 230 can be dimensioned to accommodate a switch dome 116 having one or more features as described herein. The switch contacts 202, 204 can be electrically connected to terminals 206 shaped over one edge of the molded housing 230.

A second side of the molded housing 230 (generally opposite from the first side) can be configured to include a teeth-equipped aperture having teeth 238 for receiving and operating with drive wheels 232 and a rotor 120 as described herein. A sliding contact 124 can be mounted on side of the rotor 120 opposite from the first side of the molded housing 230, and such a sliding contact can be configured to engage the resistive pattern 126 implemented on a separate lead frame element 236.

In the example of FIGS. 16A and 16B, the separate lead frame element 236 is shown to include terminals 214 for the potentiometer, and such terminals can be formed from leads of the lead frame. The terminals 214 can be shaped over an edge of the molded housing, opposite from the edge with the switch terminals 206.

The device 100 of FIGS. 16A and 16B is an example where switch contacts and potentiometer resistive element can be implemented on surfaces of different structures or components. As described herein, the device 100 of FIG. 9 is another example where switch contacts and potentiometer resistive element can be implemented on surfaces of different structures or components. It will be understood that other configurations can also be implemented.

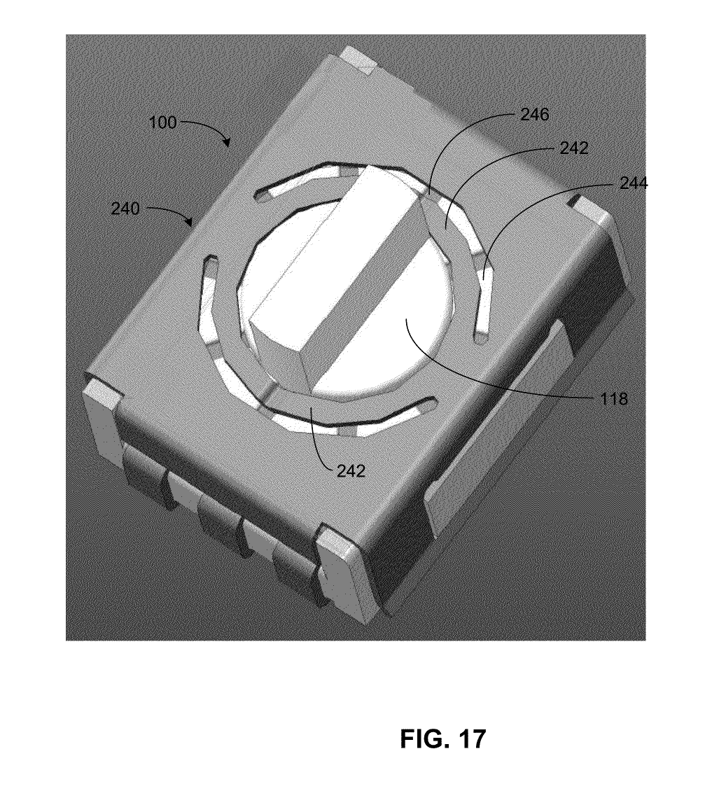

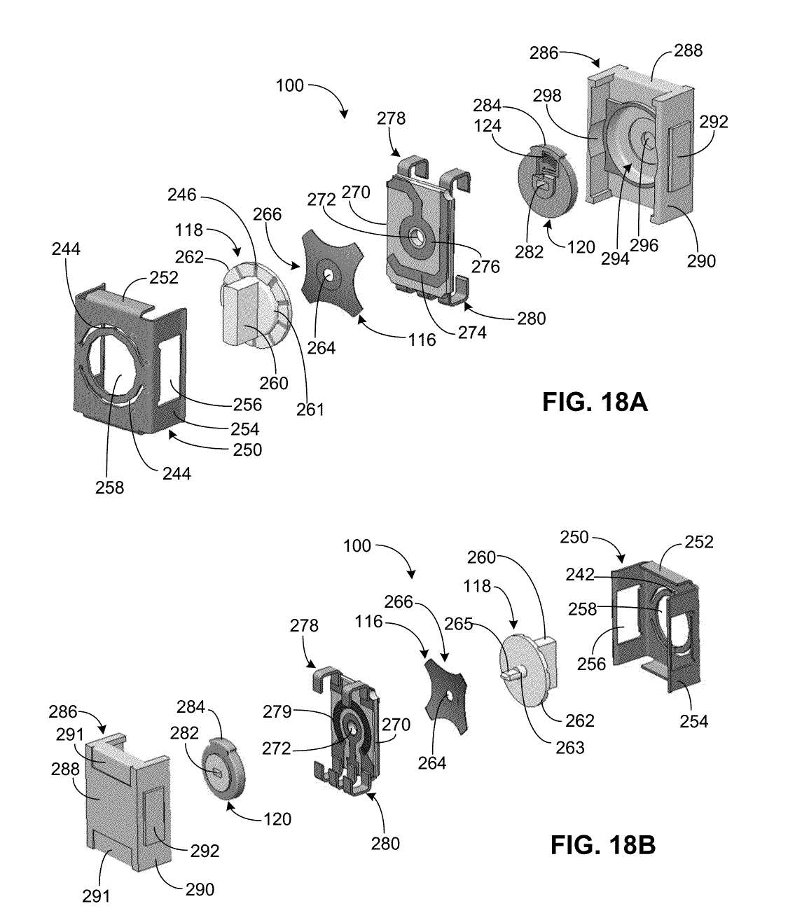

FIGS. 17 and 18 show another example of a device 100 having a switch and a potentiometer integrated therein. FIG. 17 shows an assembled view of the device 100, and FIGS. 18A and 18B show unassembled views of the same device 100.

Referring to FIGS. 18A and 18B, the switch and potentiometer functionality of the device 100 can be facilitated by a lead frame element 270, similar to the example lead frame elements 112 of FIGS. 14 and 15. More particularly, one side of the lead frame element 270 can include switch contacts 274, 276 configured to provide momentary switching functionality along with a conductive switch dome 116. As described herein, such a switch dome can be shaped such that when in a relaxed form, one or more of its edge portions is/are in electrical contact with the switch contact 274, but the rest of the switch dome 116 is not in electrical contact with the other switch contact 276. When the middle portion of the switch dome 116 is pushed by an actuator 118 towards the lead frame element 270, the middle portion can come into contact with the switch contact 276, and thereby form a closed circuit between the switch contacts 274, 276. When the actuator 118 is released, the switch dome 116 returns to its relaxed form, thereby opening the circuit between the switch contacts 274, 276.

As also described herein, switch terminals 278 are in electrical contact with the switch contacts 274, 276; thus, the foregoing switching actions can result in the terminals 278 being temporarily connected electrically, or disconnected, depending on the action of the actuator 118. In some embodiments, the switch dome 116 can include one or more cutouts 266 to yield a desirable mechanical properties during the flexing and relaxing actions, as well as to allow, for example, routing of the switch contact 276 and providing the foregoing switching functionalities.

Referring to FIGS. 18A and 18B, the other side of the lead element 270 can include a resistive element 279 configured to provide potentiometer functionality. Such a resistive element can be engaged by a sliding contact 124 mounted on a rotor 120. In some embodiments, the rotor 120 can include an extended portion 284 configured to accommodate the sliding contact 124.

In the example of FIGS. 18A and 18B, the rotor 120 can be turned by a key portion 265 of a shaft 263 of the actuator 118 inserted into a keyhole 282 of the rotor 120. As described herein, the key portion 265 can slide through the keyhole 282, along the longitudinal axis of the shaft 263, such that the rotor can be turned (with the sliding contact 124 engaged with the resistive element 279) regardless of whether the switch is OFF or ON. To facilitate such longitudinally sliding motion of the shaft 263, each of the lead frame element 270 and the switch dome 116 can include an appropriately dimensioned hole. For the lead frame element 270, such a hole is indicated as 272, and for the switch dome 116, such a hole is indicated as 264.

As also described herein, potentiometer terminals 280 are in electrical contact with the resistive element 279 and the collector; thus, the foregoing terminals 280 can be utilized to provide potentiometer functionality.

Referring to FIGS. 17 and 18, various components described above can be implemented in a housing 240 which can include, for example, a front lid 250 and a molded back 286. The molded back 286 can include upper and lower edges 288 dimensioned to allow the switch terminals 278 and the potentiometer terminals 280 to be formed around them. The bent portions of such terminals can be partially received by shallow recesses 291 defined on the backside 288 of the molded back 286.

On the interior side of the molded back 286, an opening 294 can be formed to accommodate the rotor 120. Such an opening can further define a center recess 296 to generally retain the key portion 265 of the actuator 118, and to accommodate the longitudinal motion of the key portion 265. In the example of FIGS. 17 and 18, side walls 290 of the molded back 186 are shown to include cutouts 298 dimensioned to facilitate the rotation of the rotor 120.

In some embodiments, the front lid 250 can be formed as, for example, a metal lid having a front face, side walls 254, and upper and lower extensions 252. The front face can include an opening 258 configured to retain the actuator 118 and yet allow a portion of the actuator (e.g., a turning tab 260) to extend outward to allow control of the switch and/or the potentiometer. Such an actuator and the front face can be configured in a number of different manners; and non-limiting examples are described herein in greater detail.

In some embodiments, the side walls 254 of the lid 250 can define cutouts 256 dimensioned to snap over protrusions 292 formed on the side walls 290 of the molded back 286. Accordingly, such engagements between the lid 250 and the molded back 286 can allow the housing to be robust, yet allow the lid to be removed if necessary or desired.

In some embodiments, the upper and lower extension 252 can be dimensioned to generally cover the inner sides of the upper and lower edges 288 of the molded back 286. If such upper and lower extensions (252) are formed of an electrically conductive material such as metal, they can be dimensioned appropriately to provide the cover functionality while not electrically shorting the terminals 278, 280.

Referring to FIGS. 17 and 18, it is noted that in some embodiments, the front face of the housing 240 and/or the actuator 118 can be configured to provide a visual indication of rotational position of the rotor 120, which can be indicative of the potentiometer setting. In some embodiments, a mechanism can be implemented to provide a positive indication of a rotational step of the rotor, which can correspond to a step change in the potentiometer setting.

In FIGS. 17 and 18, the example front face of the housing 240 can include one or more azimuthal slits 244 implemented to allow viewing of markers 246 on a disk 262 which can be part of the actuator 118. For example, ten of such markers can be distributed evenly over the full 360 degree azimuth. In such an example, the angle between two angularly adjacent markers can be approximately 36 degrees. It will be understood that other numbers of markers can be utilized.

In FIGS. 17 and 18, the example actuator 118 is shown to include a circular raised portion 261 on the disk 262 with the markers 246. Such a circular raised portion can be dimensioned to allow the turning tab 260 to extend out toward the front through the opening 258 without much side-to-side play, and to have the disk 262 engage the inner side of the front face of the housing 240 in a generally flush manner.

In FIGS. 17 and 18, the example markers 246 on the disk 262 can be formed as segment shaped recesses. At the mid-portion of each of the two azimuthal strips between the corresponding azimuthal slit 244 and the opening 258, a detent feature (242 in FIG. 18B) can be implemented to generally mate with the foregoing recess associated with a given marker. Accordingly, such detent features can provide a positive mechanical indication of a rotational step of the rotor.

In the detent feature example of FIGS. 17 and 18, it is noted that implementation of the detent features on the azimuthal strips can be beneficial, since such strips can flex outward in a leaf spring manner. Thus, as the actuator 118 is turned, the detent features 242 can be forced out of the corresponding marker recesses 246 easier due to such flexing of the azimuthal strips.

It is noted that if the foregoing visual and/or mechanical indicator functionalities are not needed or desired, the front face of the housing can be implemented in a simpler manner. For example, a simple opening can be implemented to accommodate the actuator, and the azimuthal slits do not need to be formed.

In the example shown in FIGS. 17 and 18, the front lid 250 can be formed from sheet metal, and the molded back 286 can be formed from plastic. Other materials can be utilized.

In some embodiments, moving parts such as the actuator can be formed from different materials, depending on applications and/or size of the device. For example, if a relatively small device is desired, a smaller rotor can be utilized; and such a smaller rotor can be rotated by a smaller shaft. To provide sufficient strength and torque without damaging the shaft, a suitable material such as metal can be utilized.

It is noted that a smaller device such as the example of FIGS. 17 and 18 can be beneficial in other ways. For example, suppose that the switch dome (116) has a selected lateral dimension to provide desirable mechanical properties (e.g., flexing strength, actuation feel, etc.). If a device is significantly larger than the lateral dimension of the switch dome, a corresponding housing may need to include a dedicated cavity to constrain the dome from rotating (e.g., when the actuator is rotated). However, if a device has a similar dimension as the lateral dimension of the switch dome, the housing itself can constrain the dome without any dedicated cavity.

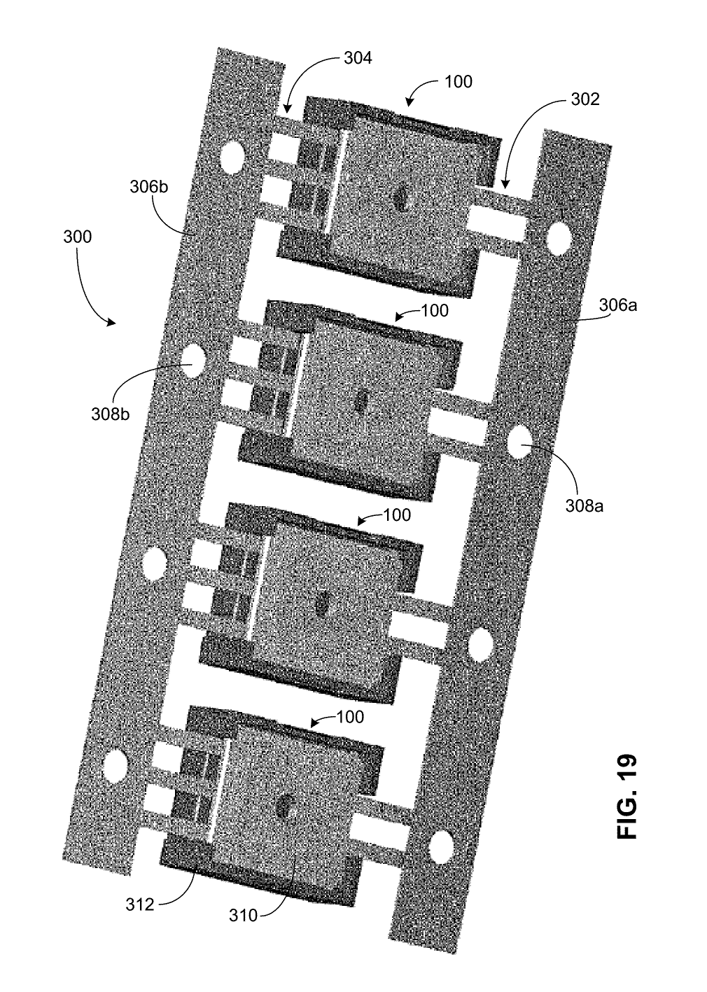

FIG. 19 shows that in some embodiments, integrated potentiometer and momentary switch devices 100 having one or more features as described herein can be fabricated in an array utilizing lead frame technology. For example, the lead frame elements of FIGS. 14, 15 and 18 can be fabricated based on a series of lead frames (e.g., in a reel). A structure such as a molded plate can be formed about a given set of lead frames, and conductive traces on the switch side, as well as resistive pattern on the potentiometer side, can be formed on such a plate. Appropriate electrical connections can be made for such traces and resistive pattern. In some embodiments, such lead frames can be cut and become the terminals by, for example, being bent around an outer housing.

In the example of FIG. 19, a lead frame configuration 300 is shown to include a single row of a plurality of device units 100 are shown to be attached to lead frames 306a, 306b through their respective leads 302, 204. As described herein, the leads 302 can be utilized to form terminals for switch contacts, and the leads 304 can be utilized to form potentiometer terminals. In some embodiments, a lead frame configuration can include a plurality of rows of device units, to thereby define a two-dimensional array.

In the example of FIG. 19, a molded housing component 312 is shown to be implemented for each of the device units 100. It will be understood that other fabrication operations can also be performed while the device units 100 are still attached to the lead frames 306a, 306b.

In FIG. 19, the example lead frames 306a, 306b can include indexing features such as indexing holes 308a, 308b. Such indexing features can facilitate, for example, movement of the lead frame, indexing of a device unit relative to the corresponding indexing holes, etc.

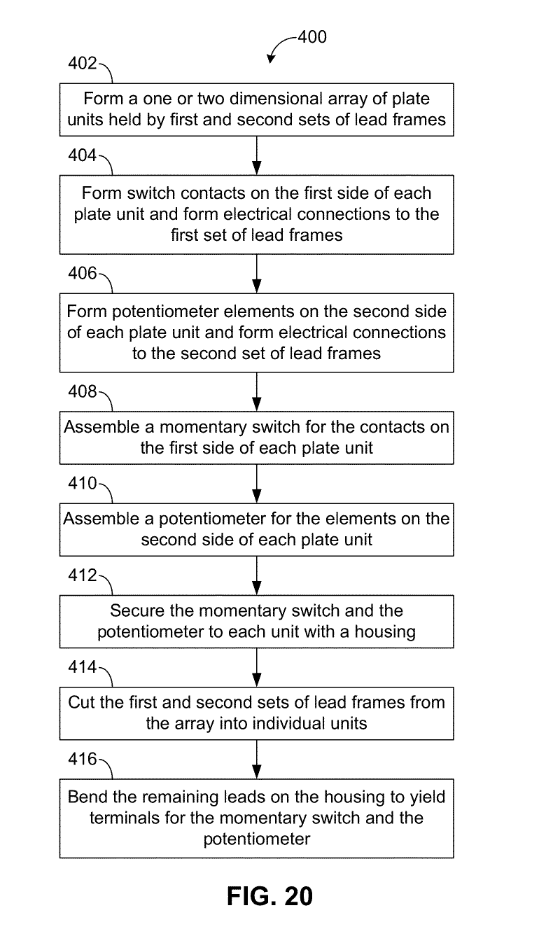

FIG. 20 shows an example process 400 that can be implemented to fabricate a plurality of devices having one or more features as described herein. In block 402, a one or two dimensional array of lead units can be provided. For each of such units, a plate can be formed so as to be held by the corresponding leads and lead frames. For the purpose of description, such leads can include a first set for a switch, and a second set for a potentiometer; however, it will be understood that one or more features of the present disclosure can also be implemented where only one set of leads is utilized in a lead frame configuration.

In block 404, switch contacts can be formed on the first side of each plate unit, and electrical connections can be formed between such contacts and the first set of leads. In block 406, potentiometer elements can be formed on the second side of each plate unit, and electrical connections can be formed between such elements and the second set of leads. It will be understood that formations of the electrical connections in blocks 404 and 406 can be performed separately, generally together after the formations of switch contacts and the potentiometer elements, or any combination thereof.

In block 408, a momentary switch can be assembled for the contacts on the first side of each plate unit. In block 410, a potentiometer can be assembled for the elements on the second side of each plate unit. In block 412, the momentary switch and the potentiometer can be secured to each unit with, for example, a housing.

In block 414, the first and second sets of leads can be cut from the lead frame to separate the individual device units from the array. In block 416, the leads remaining with each individual device unit can be bent on the housing to yield terminals for the momentary switch and the potentiometer.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A device comprising:
a housing;
one or more structures implemented within the housing and defining a first surface and a second surface;
a switch implemented on the first surface;
a potentiometer implemented on the second surface; and
an actuator mechanism configured to allow the switch to transition between ON and OFF states, the actuator mechanism further configured to allow adjustment of the potentiometer when the switch is in the ON state or the OFF state.

2. The device of claim 1, wherein the switch is a momentary switch.

3. The device of claim 2, wherein the one or more structures includes a plate having a first side defining the first surface and a second side defining the second surface.

4. The device of claim 3, wherein the switch includes first and second switch contacts implemented on the first surface, and the potentiometer includes a resistive element implemented on the second surface.

5. The device of claim 4, wherein the actuator mechanism includes a shaft that extends between the first and second sides of the plate.

6. The device of claim 5, wherein the switch further includes a flexible conductor configured to electrically connect or disconnect the first and second switch contacts, depending on a longitudinal position of the shaft.

7. The device of claim 6, wherein the flexible conductor includes a dome-shaped conductor configured to deform in a restorable manner.

8. The device of claim 7, wherein the actuator mechanism is configured to allow adjustment of the potentiometer in any shape state of the dome-shaped conductor.

9. The device of claim 4, wherein the potentiometer includes a rotor coupled to the shaft, the rotor configured to facilitate variable resistance settings between respective ends of the resistive element and a collector node.

10. The device of claim 9, wherein the rotor includes a sliding contact configured to slide along the resistive element when the rotor is turned by the shaft.

11. (canceled)

12. (canceled)

13. The device of claim 10, wherein the rotor is coupled substantially directly to the shaft in a slidable manner.

14. The device of claim 13, wherein the shaft includes a drive key and the rotor includes a keyhole dimensioned to receive the drive key, such that rotation of the shaft results in rotation of the rotor.

15. The device of claim 14, wherein the drive key is dimensioned with sufficient length to allow longitudinal motion of the drive key through the keyhole as the shaft is moved to transition the switch between the ON and OFF states.

16. (canceled)

17. The device of claim 9, wherein the housing includes a front lid and a molded back implemented such that the plate is positioned between the front lid and the molded back.

18. The device of claim 17, wherein the switch is implemented between the plate and the front lid, and the potentiometer is implemented between the plate and the molded back.

19. The device of claim 18, wherein the actuator includes a turn-facilitating feature implemented at a front end of the shaft, and the front lid includes an opening to facilitate turning of the shaft with the turn-facilitating feature.

20. (canceled)

21. The device of claim 19, wherein the actuator further includes a disk implemented to be positioned adjacent an inner surface of the front lid to retain the actuator inward of the front lid.

22. The device of claim 21, wherein the disk includes either or both of a visual indicator and a detent receiver, the visual indicator configured to provide an indication of a rotational position of the rotor of the potentiometer, the detent receiver configured to provide a mechanical indication of a step of rotation of the rotor of the potentiometer.

23. The device of claim 22, wherein the front lid includes one or more slits configured to allow viewing of the visual indicator of the disk.

24. The device of claim 23, wherein the one or more slits are formed to yield one or more corresponding strips on the front lid between the one or more slits and the opening of the front lid.

25. The device of claim 24, wherein at least one of the one or more strips includes a detent feature configured to engage with the detent receiver of the disk.

26. (canceled)

27. A method for fabricating an electronic device, the method comprising:
forming or providing a housing;
forming or providing one or more structures within the housing and defining a first surface and a second surface;
implementing a switch on the first surface;
implementing a potentiometer on the second surface; and
implementing an actuator to allow the switch to transition between ON and OFF states, and to allow adjustment of the potentiometer when the switch is in the ON state or the OFF state.

28. A method for fabricating a plurality of electronic devices, the method comprising:
forming or providing a lead frame assembly having an array of lead units attached to one or more frames;
forming a plate for each lead unit;
implementing a switch on a first surface of each plate; and
implementing a potentiometer on a second surface of each plate

29. (canceled)

30. (canceled)

31. (canceled)

32. (canceled)

33. (canceled)
